(19) United States
(12) Patent Application Publication
(10) Pub. No.: US 2010/0061431 A1
(43) Pub. Date: Mar. 11, 2010

(54) POWER SAVING IN A RADIO FREQUENCY MODEM

(75) Inventors: Kari Jyrkka, Oulu (FI); Mika Kaukoranta, Oulu (FI); Asko Haapapuro, Oulu (FI); Matti Vuori, Salo (FI); Jori Arrakoski, Espoo (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/520,199

(22) PCT Filed: Dec. 22, 2006
(86) PCT No.: PCT/IB2006/055021

§ 371 Date: Nov. 3, 2009

(51) Int. Cl. H04B 7/00; H04B 1/38

(52) U.S. Cl. 375/220; 455/522

(57) ABSTRACT

A radio frequency (RF) modem for a mobile communications device comprises a monitoring circuit; an RF circuit having a demodulator, the RF circuit being for receiving RF signals; a baseband processing unit, for processing baseband signals; and a controller. The RF modem can enter a sleep mode in which the monitoring circuit is operational and the RF circuit and the baseband processing unit are not operational. The controller is responsive to an indication from the monitoring circuit to control the RF modem to enter a monitoring mode in which the RF circuit is operational and the baseband processing unit is not operational. The RF circuit is configured for data reception in the monitoring mode. The controller then controls the RF modem to exit the monitoring mode and to enter a baseband processing mode in which the baseband processing unit is operational to process data signals provided by the RF circuit.

The present invention relates to a radio frequency modem for a mobile communications device, and a method of operating a radio frequency modem for a mobile communications device.

Radio frequency modems are used in digital mobile communications devices to transmit digital data using an analogue carrier signal, and comprise both digital and analogue circuitry. To transmit a signal, a radio frequency signal is generated by modulating a digital baseband signal onto a radio frequency carrier wave. When receiving a signal, the received radio signal is demodulated to extract the baseband signal. One or more baseband processors are used to decode digital data from the baseband signal.

In the past, the functionality of mobile communications devices was limited to voice calls and low data rate calls. This functionality could be provided by a modem and a user interface only. Due to the simplicity of these mobile communications devices, they could be optimised for modem functionality.

Mobile communications devices that are currently available are capable of performing many functions. Examples of these functions are voice calls, high data rate circuit switched and packet switched calls, digital photography, video recording and playback, games, and location applications. Many components are required to perform these functions, and as a result the design of these devices continues to become increasingly complex. Current mobile communications devices are not optimised for modem functionality, and tend to use the same hardware platform for implementing all their functions.

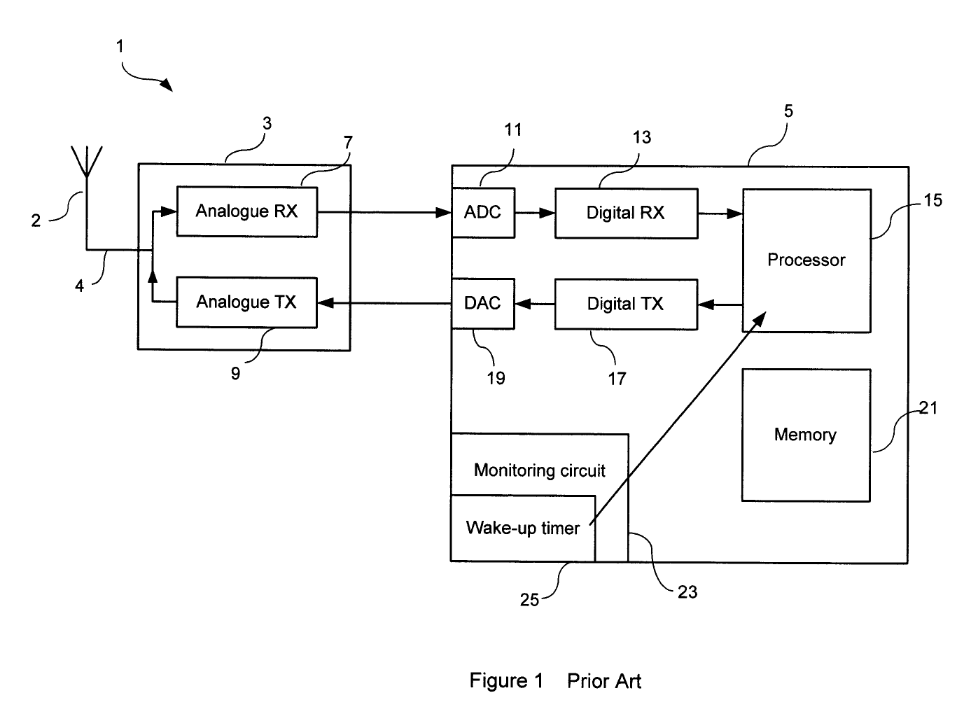

Referring to FIG. 1, a prior art radio frequency (RF) modem 1 for a mobile communications device comprises a connection 4 to an antenna 2, an RF application specific integrated circuit (ASIC) 3 and a baseband ASIC 5.

The RF ASIC 3 comprises an analogue receiver circuit 7 and an analogue transmission circuit 9. The analogue receiver circuit 7 provides a baseband signal from a received RF signal by demodulating the received signal.

The baseband ASIC 5 comprises an analogue to digital converter (ADC) 11, digital receiver hardware 13, and a processor 15. The ADC 11 converts the baseband signal received by the analogue receiver circuit 7 to a digital signal. The digital receiver hardware 13 and the processor 15 process the baseband signal to extract data.

The baseband ASIC 5 also comprises digital transmission hardware 17 and a digital to analogue converter (DAC) 19, for encoding data and generating an analogue baseband signal to be modulated by the analogue transmission circuit 9.

The baseband ASIC 5 further comprises a memory 21, and a monitoring circuit 23 having a wake-up timer 25. The monitoring circuit 23 includes logic for detecting interrupts, logic for powering up processors, and logic for gating clocks. The monitoring circuit 23 is powered when the baseband ASIC 5 is in sleep mode, and for this reason can be described as being present in an always active area of the baseband ASIC 5.

The prior art RF modem 1 has two modes of operation, namely an idle mode and an active mode.

In idle mode, the RF modem 1 listens to a common control channel for page messages. During idle mode the RF modem 1 is in typically in a sleep state for most of the time. In the sleep state, only the monitoring circuit 23 is powered, and is clocked by a low-frequency clock (not shown). All the components of the RF ASIC 3 and all the other components of the baseband ASIC 5 are not powered.

In a cellular system such as GSM or WCDMA, the mobile communications device is required to receive page messages at predetermined times. The typical periodicity of page messages may be between one and five seconds. The wake-up timer 25 controls the powering up of the required parts of the modem 1, via the processor 15, for receiving page messages.

To receive page messages in idle mode, the analogue receiver circuit 7, ADC 11, digital receiver hardware 13, processor 15 and memory 21 are powered. These components are clocked by a high frequency clock (not shown).

If a page message is received which indicates the existence of an incoming call, the RF modem 1 enters the active mode for receiving and transmitting data, and all parts of the RF modem 1 are powered. The RF modem 1 may also enter active mode if a user of the mobile communications device initiates a call through a user interface.

The present invention seeks to provide a radio frequency modem having improved energy efficiency.

According to a first aspect of the present invention there is provided a radio frequency (RF) modem for a mobile communications device, the RF modem comprising: a monitoring circuit; an RF circuit having a demodulator, the RF circuit being for receiving RF signals; a baseband processing unit, for processing baseband signals; and a controller, the controller being operable to enter the RF modem into a sleep mode in which the monitoring circuit is operational and the RF circuit and the baseband processing unit are not operational, the controller being responsive to an indication from the monitoring circuit to control the RF modem to enter a monitoring mode in which the RF circuit is operational and the baseband processing unit is not operational, the RF circuit in the monitoring mode being configured for data reception, and the controller being further operable to control the RF modem to exit the monitoring mode and to enter a baseband processing mode in which the baseband processing unit is operational to process data signals provided by the RF circuit.

The present invention can reduce the power consumption of a modem in idle mode by keeping the baseband processing unit unpowered for a longer period.

The present invention makes use of the fact that in the above-described system certain parts of the analogue receiver circuit 7 and the high frequency clock have a non-zero settling time. Thus, the RF ASIC 3 is not immediately ready for reception of page messages. Therefore, the baseband receiver 13 and processor 15 are powered before they can be used, and energy efficiency is not optimised in the mobile communications device.

The RF circuit may further comprise a memory, and at least one register, the memory being arranged to store default values of the at least one register and the modem may be operable in the monitoring mode to control writing of the default values to the at least one register. In addition, the RF circuit may further comprise a processor operable in the monitoring mode to control configuration of the RF circuit. This can allow the RF circuit to stabilise before the baseband processing unit is powered, so that the baseband processing unit is not powered before it is able to receive data signals from the RF circuit. Thus, power can be saved in the RF modem.

Advantageously, the RF circuit may further comprise an analogue to digital converter and digital logic, and the processor may be operable to control the RF circuit in the monitoring mode to process a received information signal. This can allow the baseband processing unit to remain unpowered until the RF modem is required for sending and receiving data, thus saving a significant amount of power in the RF modem. In addition, because the amount of logic required to perform this processing is less than the amount of logic required to send and receive data, the amount of digital logic provided on the RF circuit can be less than the amount of digital logic required in a system in which all the processing is performed in baseband ASIC digital logic. Thus, power can also be saved in idle mode since the amount of logic that is controlled in idle mode can be lower.

According to a second aspect of the present invention there is provided a method of operating a radio frequency (RF) modem for a mobile communications device, the RF modem comprising: a monitoring circuit; an RF demodulator circuit, for receiving RF signals; a baseband processing unit, for processing baseband signals; and a controller, the method comprising: controlling the RF modem to enter a sleep mode in which the monitoring circuit is operational and the RF demodulator circuit and the baseband processing unit are not operational; controlling the RF modem to respond to an indication from the monitoring circuit by entering a monitoring mode in which the RF demodulator circuit is operational for data reception and the baseband processing unit is not operational; controlling the RF modem to exit the monitoring mode and to enter a baseband processing mode in which the baseband processing unit is operational to process data signals provided by the RF demodulator circuit.

Embodiments of the present invention will now be described, by way of example only, with reference to the accompanying drawings in which:

FIG. 1 illustrates a prior art RF modem;

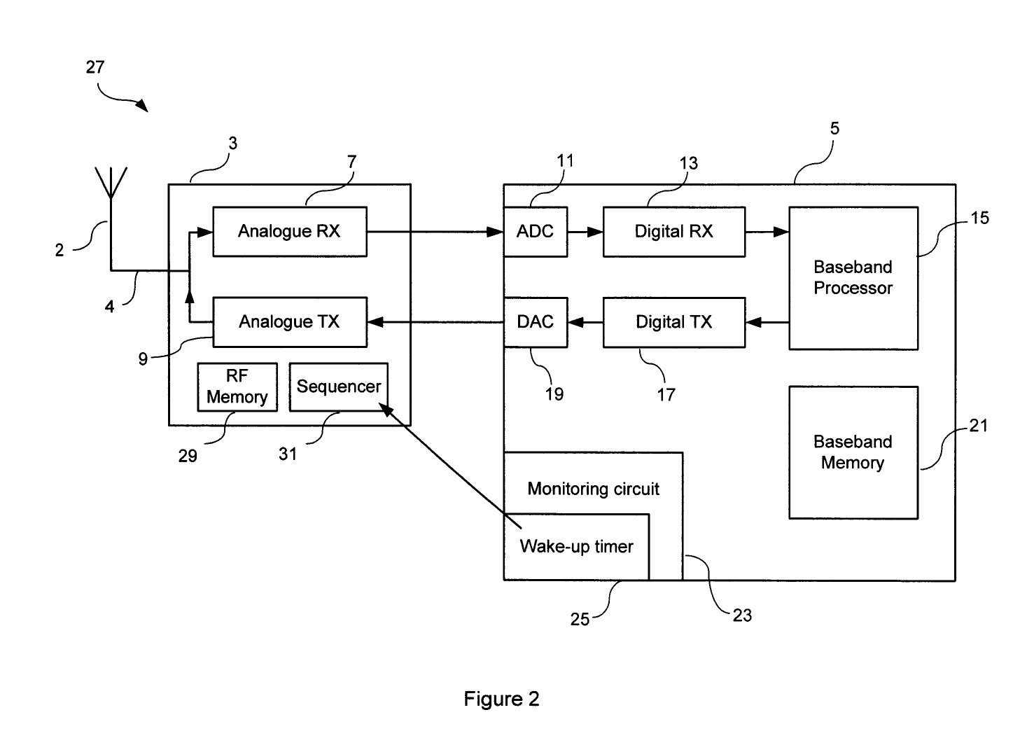

FIG. 2 is a schematic of a first embodied RF modem according to the present invention;

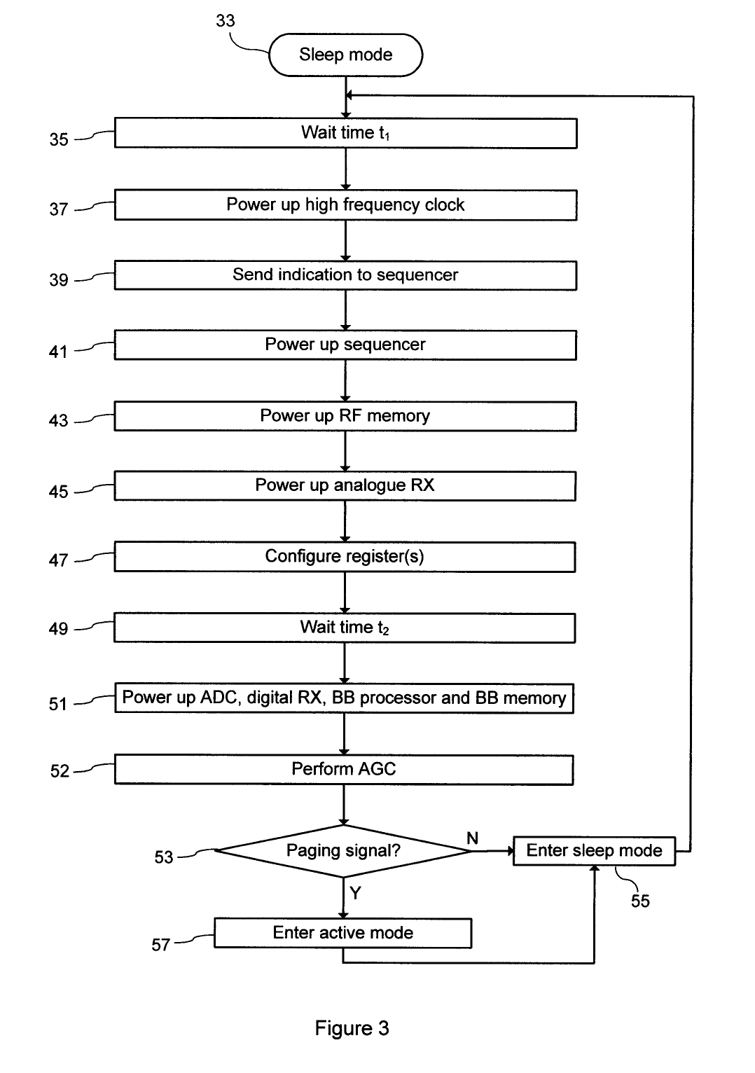

FIG. 3 is a flow diagram of a method of operating the FIG. 2 modem;

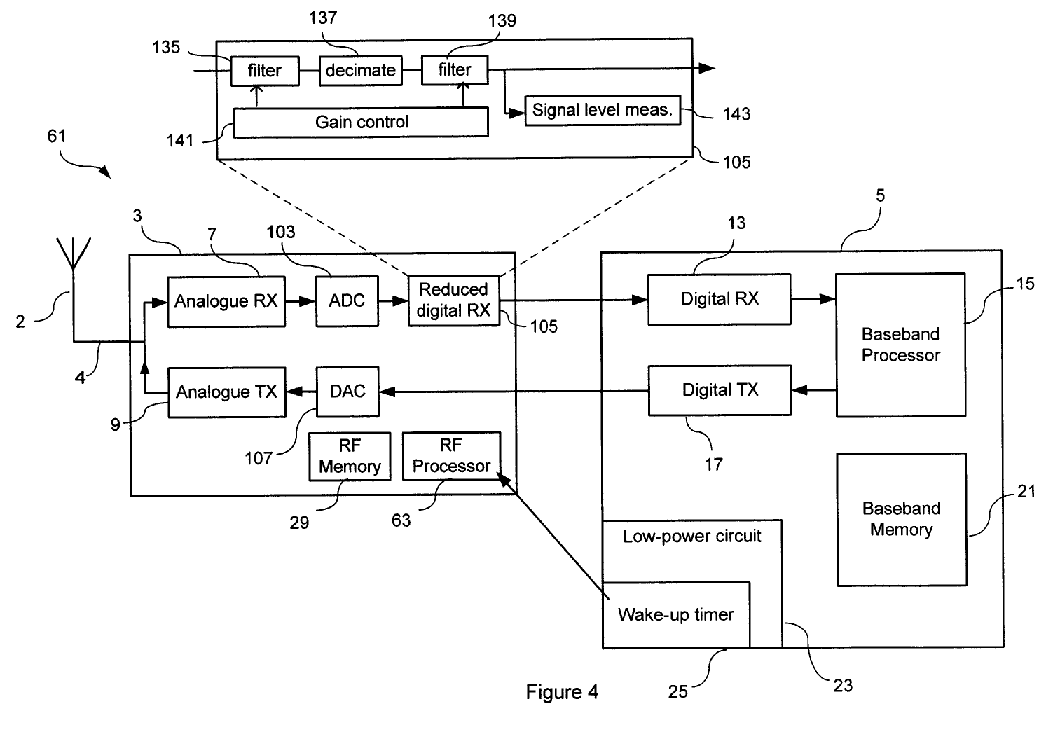

FIG. 4 is a schematic of a second embodied RF modem according to the present invention;

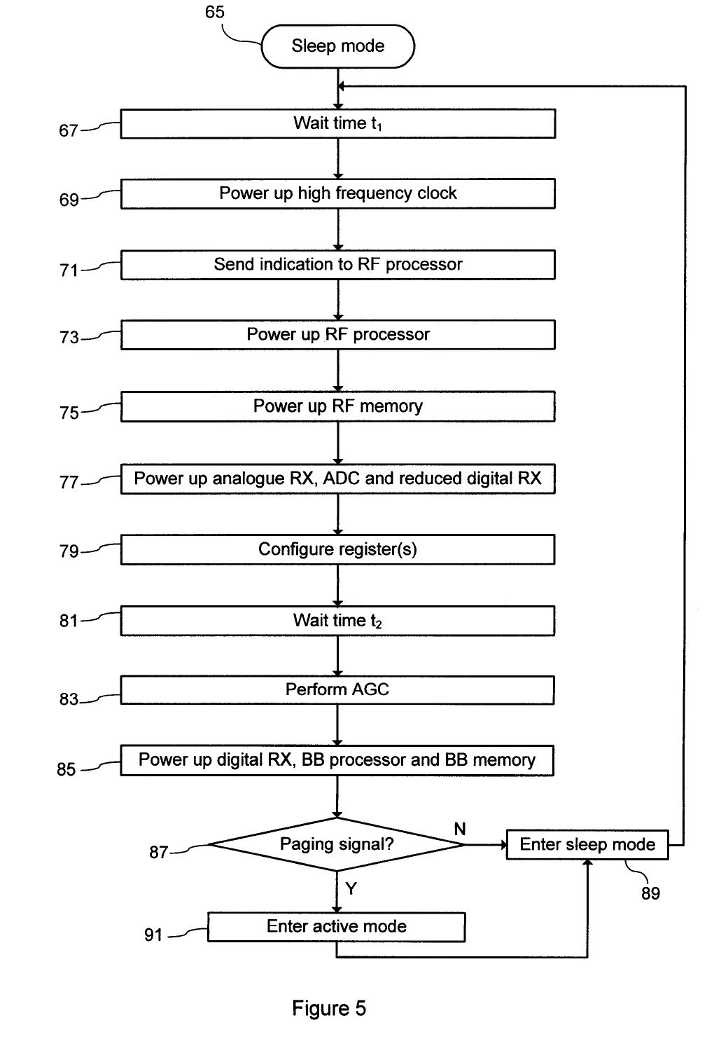

FIG. 5 is a flow diagram of a method of operating the FIG. 4 modem;

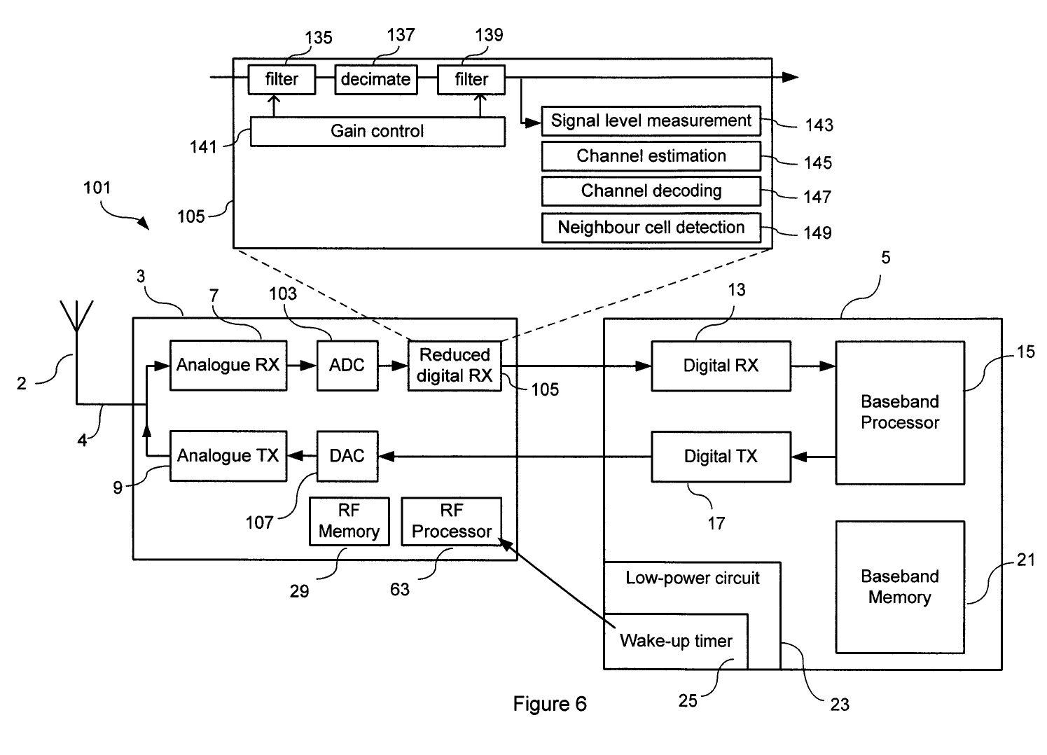

FIG. 6 is a schematic of a third embodied RF modem according to the present invention; and

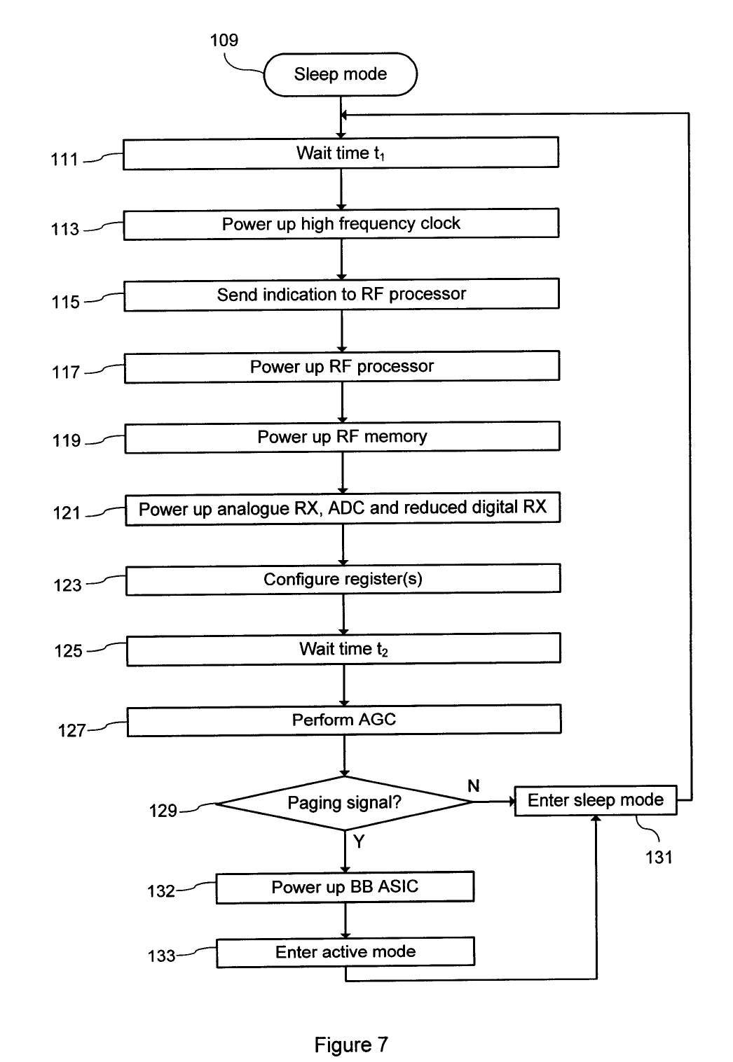

FIG. 7 is a flow diagram of a method of operating the FIG. 6 modem.

In the Figures, reference numerals are re-used for like element throughout.

Referring firstly to FIG. 2, an RF modem 27 comprises an RF ASIC 3, a baseband ASIC 5, and a connection 4 to an antenna 2.

The RF ASIC 3 includes an analogue receiver circuit 7 and an analogue transmission circuit 9. The analogue receiver circuit 7 and the analogue transmission circuit 9 can have the same structure as their counterparts in FIG. 1 RF modem 1.

The RF ASIC 3 also includes a memory 29, hereafter referred to as the RF memory 29, and a sequencer 31 (implemented as a hardware state machine). The RF memory 29 is a non-volatile memory, so retains the information stored in it when it is not powered. The sequencer 31 is operable to control start-up and configuration of the analogue receiver circuit 7.

The analogue receiver circuit 7 has at least one register (not shown). These registers store information for configuration and start-up of the analogue receiver circuit 7, such as default voltage values. The information in these registers is not retained when the analogue receiver circuit 7 is powered down. The RF memory 29 is pre-programmed with the default values of the registers of the RF ASIC 3, before the RF ASIC 3 is powered down.

The baseband ASIC 5 comprises an ADC 11, a digital receiver circuit 13, a baseband processor 15, a digital transmission circuit 17, a DAC 19, and a memory 29, hereafter referred to as the baseband memory 21. These components can have the same structure as their counterparts in the FIG. 1 RF modem 1.

The baseband ASIC 5 also comprises a monitoring circuit 23 and a wake-up timer 25, which can also have the same structure their counterparts in the prior art RF modem 1. However, in this embodiment the wake-up timer 25 communicates with the sequencer 31 on the RF ASIC 3 instead of with the baseband processor 15 on the baseband ASIC 5.

The RF modem 27 is operable in an idle mode and in an active mode. In idle mode, the RF modem is operable in one of a sleep mode, a first monitoring mode, and a second monitoring mode.

When the RF modem 27 is not required for transmitting or receiving data, and is not performing monitoring such as page monitoring or neighbour cell monitoring, it is in sleep mode. In sleep mode all the components of the RF ASIC 3 are not powered. The ADC 11, digital receiver circuit 13, baseband processor 15, digital transmission circuit 17, DAC 19 and baseband memory 21 of the baseband ASIC 5 also are not powered. The monitoring circuit 23, including the wake-up timer 25, is powered, and is clocked by a low frequency clock (not shown). A high frequency clock (not shown) is not run in sleep mode.

The RF modem 27 can in the first monitoring mode and the second monitoring mode listen to monitoring signals. In the first monitoring mode, the analogue receiver circuit 7, the RF memory 29, the sequencer 31 and the monitoring circuit 23, including the wake-up timer 25, are powered. The sequencer 31 is clocked by the high frequency clock. The remaining components of the RF modem 27 are not powered.

In the second monitoring mode, the analogue receiver circuit 7, the RF memory 29, the sequencer 31 and the monitoring circuit 23, including the wake-up timer 25, are powered. The ADC 11, the digital receiver circuit 13, the baseband processor 15, and the baseband memory 21 are also powered. The analogue transmission circuit 9, DAC 19 and digital transmission circuit 17 are not powered.

In active mode, all the components of the RF modem 27 are powered.

Referring to FIG. 3, a method of operating the RF modem 27 will now be described.

The operation starts at step 33, with the RF modem 27 in sleep mode. At step 35, the wake-up timer waits for a first pre-determined time t₁. The first pre-determined time t₁ is set by the operating standard, such as GSM and WCDMA. After the first pre-determined time t₁ has passed, the operation proceeds to step 37. At step 37, the wake-up timer 25 sends a signal to a sequencer (not shown) for powering-up the high frequency clock. Step 37 represents the start of a sequence of actions by which the RF modem 27 enters the first monitoring mode.

At step 39, the wake-up timer sends an indication to the sequencer 31. This causes the sequencer 31 to be powered up at step 41.

The sequencer 63 then controls configuration of the RF ASIC 3. First, at step 43, the sequencer controls the RF memory 29 to be powered up. At step 45, the sequencer 31 controls the analogue receiver circuit 7 to be powered up. At step 47, the sequencer controls the writing of default values to the registers of the analogue receiver circuit 7, using the default values stored in the RF memory 29.

The sequencer 63 then controls the RF modem 27 to wait a second pre-determined time t₂, this time being set to be sufficient for the analogue receiver circuit 7 and the high frequency clock to stabilise. After the second pre-determined time t₂, the operation proceeds to step 51, which represents the start of a sequence of actions by which the RF modem 27 enters the second monitoring mode.

At step 51, the ADC 11, digital receiver circuit 13, baseband processor 15 and baseband memory 21 are powered up. At step 52, the baseband processor 15 controls automatic gain control (AGC) on a received carrier signal. At step 53, it is determined by the baseband processor 15 if a paging signal has been received. A paging signal may relate for instance to a voice call, a voice mail, or a short or multimedia message.

If a paging signal that addresses the device including the RF modem 27 has not been received, the operation proceeds to step 55 and the mobile device enters sleep mode under control of the baseband processor 15 and the sequencer 31. The operation then returns to step 35.

If a paging signal that addresses the device including the RF modem 27 is received, the operation proceeds to step 57 and the RF modem 27 enters active mode. In active mode, all the components of the RF ASIC 3 and baseband ASIC 5 are powered for reception and transmission of data. Once the active mode is no longer required, the operation proceeds to step 55 where the RF modem 27 enters sleep mode. The operation then returns to step 35.

As a result of the above-described operation, the components of the baseband processor 5 are not powered until the analogue receiver circuit 7 and the high power clock have stabilised. This provides a power saving in the RF modem 27.

The RF modem 27 may also be operable to perform monitoring of neighbour cell signal levels, quality and timing while it is in the second monitoring mode.

Referring now to FIG. 4, a second embodiment of an RF modem 61 comprises an RF ASIC 3 and a baseband ASIC 5.

The RF ASIC 3 includes an analogue receiver circuit 7 and an analogue transmission circuit 9. These components can have the same structure as their counterparts in the FIG. 2 RF modem 27. An output of the analogue receiver circuit 7 is connected to the input of an ADC 103. An output of the ADC 103 is connected to an input of a reduced digital receiver circuit 105. The RF ASIC 3 also includes an RF memory 29 and a simple processor, hereafter referred to as the RF processor 63. The RF processor 63 is operable to control start-up and configuration of the analogue receiver circuit 7, and is also operable to control automatic gain control at the reduced digital receiver circuit 105.

The reduced digital receiver circuit 105 includes limited logic for receiving digital baseband signals. In particular, the reduced digital receiver circuit 105 includes a first filtering block 135, a decimation block 137, a second filtering block 139, a gain control block 141 and a signal measuring block 143.

The baseband ASIC 5 comprises a digital receiver circuit 13, a baseband processor 15, a digital transmission circuit 17 and a baseband memory 21. The baseband ASIC 5 also includes a monitoring circuit 23, including a wake-up timer 25, that is clocked by a low frequency clock (not shown).

In this embodiment, the baseband ASIC 5 does not include an ADC or a DAC, as the RF ASIC 3 provides digital signals to the baseband ASIC 5 and receives digital signals from the baseband ASIC 5.

The RF modem 61 is operable in an idle mode and in an active mode. In idle mode, the RF modem is operable in one of a sleep mode, a first monitoring mode, and a second monitoring mode.

When the RF modem 61 is not required for transmitting or receiving data, and is not performing monitoring such as page monitoring or neighbour cell monitoring, it is in sleep mode. In sleep mode, all the components of the RF ASIC 3 and all the components of the baseband ASIC 5 other than the monitoring circuit 23 including the wake-up timer 25 are not powered. The monitoring circuit 23 is clocked using a low frequency clock (not shown), and a high frequency clock (not shown) is not powered.

The RF modem 61 can in the first monitoring mode and the second monitoring mode listen to monitoring signals. In the first monitoring mode, the analogue receiver circuit 7, the ADC 103, the reduced digital receiver circuit 105, the RF memory 29, the RF processor 63 and the monitoring circuit 23, including the wake-up time 25, are powered. The RF processor 63 is clocked by the high frequency clock. The remaining components of the RF modem 61 are not powered.

In the second monitoring mode, the analogue receiver circuit 7, the ADC 103, the reduced digital receiver circuit 105, the RF memory 29, the RF processor 63 and the monitoring circuit 23, including the wake-up timer 25, are powered. The the digital receiver circuit 13, the baseband processor 15, and the baseband memory 21 of the baseband ASIC 5 are also powered. The analogue transmission circuit 9, DAC 107 and digital transmission circuit 17 are not powered.

In active mode, all the components of the RF modem 61 are powered.

The RF modem 61 may also be operable to perform monitoring of neighbour cell signal levels, quality and timing while it is in the second monitoring mode.

Referring to FIG. 5, a method of operating the RF modem 61 will now be described.

The operation starts at step 65, with the RF modem 61 in sleep mode. At step 67, the wake-up timer waits for a first pre-determined time t₁. After the first pre-determined time t₁, the operation proceeds to step 69 where the high frequency clock is powered up. Step 69 represents the start of a sequence of actions by which the RF modem 61 enters the first monitoring mode.

At step 71, the wake-up timer sends an indication to the RF processor 63. This causes the RF processor 63 to be powered up at step 73.

At step 75, the RF processor 63 controls the RF memory 29 to be powered up. At step 77, the RF processor then controls the analogue receiver circuit 7, the ADC 103, and the reduced digital receiver circuit 105 to be powered up. At step 79, the RF processor 63 then controls the registers of the analogue receiver circuit 7 and the digital receiver circuit 105 to be set to their default values, using the values stored in the RF memory 29.

The RF processor 63 then controls the RF modem 61 to wait for a second pre-determined time t₂, this time being sufficient for the high frequency clock and the RF ASIC 3 to stabilise. After the second pre-determined time t₂ the operation then proceeds to step 83, where automatic gain control is performed on a received carrier signal at the reduced digital receiver circuit 105 under the control of the RF processor 63.

At step 85, the digital receiver circuit 13, baseband processor 15 and baseband memory 21 are powered up under control of the RF processor 63. Step 85 represents the start of a sequence of actions by which the RF mode 61 enters the second monitoring mode. At step 87, the baseband processor 15 determines if a paging signal has been received.

If a paging signal that addresses the device including the RF modem 61 has not been received the operation proceeds to step 89. At step 89, the RF modem 61 enters sleep mode under control of the baseband processor 15 and the RF processor 63. The operation then returns to step 67.

If a paging signal that addresses the device including the RF modem 61 has been received, the operation proceeds to step 91. At step 91, the RF modem 61 enters active mode under control of the baseband processor 15 and the RF processor 63. In active mode, all the components of the RF ASIC 3 and the baseband processor 5 are powered for reception and transmission of data. Once the active mode is no longer required, the operation proceeds to step 89, where the RF modem 61 enters sleep mode. The operation then returns to step 67.

The above-described operation allows the baseband ASIC 5 to remain unpowered for a longer time period than the FIG. 2 RF modem 27. This is achieved at the expense of more complex circuitry on the RF ASIC 3.

Referring now to FIG. 6, a third embodiment of an RF modem 101 comprises an RF ASIC 3, a baseband ASIC 5 and a connection 4 to an antenna 2.

The RF ASIC 3 includes an analogue receiver circuit 7 and an analogue transmission circuit 9. An output of the analogue receiver circuit 7 is connected to the input of an ADC 103. An output of the ADC 103 is connected to an input of a reduced digital receiver circuit 105.

The reduced digital receiver circuit 105 includes limited logic for receiving digital baseband signals. In particular, the reduced digital receiver circuit 105 includes a first filtering block 135, a decimation block 137, a second filtering block 139, a gain control block 141, and a signal measuring block 143. The reduced digital receiver circuit also includes a channel estimation block 145, a channel decoding block 147 and a neighbour cell detection block 149.

The RF ASIC 3 also comprises a DAC 107 having an output connected to an input of the analogue transmission circuit 9. The RF ASIC 3 further includes an RF memory 29 and an RF processor 63.

The baseband ASIC 5 comprises a digital receiver circuit 13, a baseband processor 15, a digital transmission circuit 17 and a baseband memory 21. The baseband ASIC 5 also includes a monitoring circuit 23, including a wake-up timer 25, that is clocked by a low frequency clock (not shown).

In this embodiment, the baseband ASIC 5 does not include an ADC or a DAC, as the RF ASIC 3 provides digital signals to the baseband ASIC 5 and receives digital signals from the baseband ASIC 5.

The RF modem 101 is operable in an idle mode and an active mode. In idle mode, the RF modem 101 is operable in one of a sleep mode and a monitoring mode.

When the RF modem 101 is not required for transmitting or receiving data, and is not performing monitoring such as page monitoring or neighbour cell monitoring, it is in sleep mode. In sleep mode, all the components of the RF ASIC 3 and all the components of the baseband ASIC 5 other than the monitoring circuit 23 including the wake-up timer 25 are not powered. The monitoring circuit 23, including the wake-up timer 25, is clocked using a low frequency clock (not shown), and a high frequency clock (not shown) is not powered.

The RF modem 101 can in the monitoring mode listen to monitoring signals, such as paging signals. The RF modem 101 may also be operable to perform monitoring of neighbour cell signal levels, quality and timing while it is in the monitoring mode. In the monitoring mode, the analogue receiver circuit 7, the ADC 103, the reduced digital receiver circuit 105, the RF memory 29, the RF processor 63 and the monitoring circuit 23, including the wake-up time 25, are powered. The RF processor 63 is clocked by the high frequency clock. The remaining components of the RF modem 101 are not powered.

In active mode, all the components of the RF modem 61 are powered.

Referring to FIG. 7, a method of operating the RF modem 101 will now be described.

The operation starts at step 109, with the RF modem 101 in sleep mode. At step 111, the wake-up timer 25 waits for a first pre-determined time t₁. After the first predetermined time t₁ has passed, the operation proceeds to step 113. At step 113, the wake up timer 25 operates a controller (not shown) to power up the high frequency clock. Step 113 represents the start of a sequence of actions by which the RF modem 101 enters the monitoring mode.

At step 115, the wake-up timer 25 sends an indication to the RF processor 63. This causes the RF processor 63 to be powered up at step 117. At step 119, the RF processor 63 controls the RF memory 29 to be powered up. At step 121, the analogue receiver circuit 7, the ADC 103, and a reduced digital receiver circuit 105 are powered up under control of the RF processor 63. At step 123, the RF processor 63 configures the registers of the analogue receiver circuit 7 and the digital receiver circuit 105, using default values stored in the RF memory 29.

At step 125, the RF processor 63 controls the RF modem 101 to wait for a pre-determined time t₂, this time being set to be sufficient for the RF ASIC 3 and the high frequency clock to stabilise. The operation then proceeds to step 127, where automatic gain control is performed on a received carrier signal under control of the RF processor 63. The RF processor 63, in combination with the reduced digital receiver circuit 105, then determines whether a paging signal has been received.

If a paging signal that addresses the device including the RF modem 101 has not been received the operation proceeds to step 131. At step 131, the RF modem 101 enters sleep mode under control of the RF processor 63. The operation then returns to step 111.

If a paging signal that addresses the device including the RF modem 101 has been received the operation proceeds to step 132. At step 132, the RF processor 63 controls the powering up of the baseband ASIC 5. At step 133, the RF modem 101 enters active mode, under control of the RF processor 63 and the baseband processor 15. In active mode, all the components of the baseband ASIC 5 and the RF ASIC 3 are powered for reception and transmission of data. Once the active mode is no longer required, the operation proceeds to step 131, where the RF modem 101 enters sleep mode. The operation then returns to step 111.

The RF modem 101 may also be operable to perform monitoring of neighbour cell signal levels, quality and timing while it is in the monitoring mode.

The above operation allows all the components of the baseband ASIC 5, apart from the monitoring circuit 23, to remain unpowered until the phone enters active mode for reception and transmission of data. This allows a significant amount of power to be saved in the RF modem 101 during idle mode. This requires some simple digital logic to be provided on the RF ASIC 3, increasing the complexity of fabrication of the RF ASIC 3.

In addition, the data received in idle mode has a lower data rate than data received in active mode. Because the amount of logic required to perform processing in idle mode is less than the amount of logic required to send and receive data in active mode, the amount of digital logic provided on the RF circuit can be less than the amount of digital logic required in a system in which all the processing is performed in baseband ASIC digital logic. Thus, power can also be saved in idle mode since the amount of logic that is controlled in idle mode can be lower. It will be appreciated that this can result in duplication of logic on the RF ASIC 3 and baseband ASIC 5, thus increasing the total die size.

Furthermore, since the RF ASIC 3 is independently controlled by its own processor 63, it can be tested as an independent module, instead of as a slave to the baseband ASIC 5. This allows for the provision of software architectures on the RF ASIC 3 that can conceal any peculiarities of the RF ASIC 3 hardware. Thus, the baseband ASIC 5 can be used with a variety of different RF ASIC 3 designs without the baseband ASIC 5 needing to take into account the differences.

The FIG. 6 RF modem 101 can instead be used to receive messages using an operation similar to that described with reference to FIG. 3. For example, in a first monitoring mode only the analogue receiver 7, the RF memory 29 and the RF processor 63 may be powered, where the RF ASIC 3 is operable in the first monitoring mode to configure the analogue receiver circuit 7 for data reception. In a second monitoring mode, the ADC 103 and the reduced digital receiver circuit 105 may be powered for reception of page messages.

The FIG. 6 RF modem 101 can also be used to receive messages using an operation similar to that described with reference to FIG. 5. For example, in a first monitoring mode the analogue receiver 7, the ADC 103, the automatic gain control blocks 135, 137, 139, 141, 143 of the reduced digital receiver circuit 105, the RF memory 29 and the RF processor 63 may be powered, where the RF ASIC 3 is operable in the first monitoring mode to configure the analogue receiver circuit 7 for data reception and perform automatic gain control under control of the RF processor 63. In a second monitoring mode, the channel estimation block 143, the channel decoding block 147 and the neighbour cell detection block 149 may be powered for reception of page messages and neighbour cell monitoring.

Similarly, the FIG. 4 RF modem 61 can also be used to receive messages using an operation similar to that described with reference to FIG. 3. For example, in a first monitoring mode only the analogue receiver 7, the RF memory 29 and the RF processor 63 may be powered, where the RF ASIC 3 is operable in the first monitoring mode to configure the analogue receiver circuit 7 for data reception. In a second monitoring mode, the ADC 103 and reduced digital receiver circuit 105 on the RF ASIC 3 and the digital receiver circuit 13, the baseband processor 15 and the baseband memory 21 on the baseband ASIC 5 may be powered for reception of page messages.

In all the above-described embodiments, the control of the transition between different modes is controlled by a plurality of components. These together constitute a controller. In other embodiments, the transition between different modes can be controlled using a discrete controller. This discrete controller may be provided on the RF ASIC 3 or on the baseband ASIC 5, or may be provided on a separate IC.

In any case, the RF processor 63 may detect that the RF ASIC 3 and the high power clock have stabilised by monitoring signals received from them, rather than by waiting a second predetermined time t₂.

In all the above-described embodiments, the components of the RF modem that are not required to be operational in the idle mode are unpowered. However, in other embodiments, when the components are not required to be operational they may instead be powered but not be provided with a clock signal. The term “powered” in this regard means provided with a voltage supply.

It should be realised that the foregoing examples should not be construed as limiting. Other variations and modifications will be apparent to persons skilled in the art upon reading the present application. Such variations and modifications extend to features already known in the field, which are suitable for replacing the features described herein, and all functionally equivalent features thereof. Moreover, the disclosure of the present application should be understood to include any novel features or any novel combination of features either explicitly or implicitly disclosed herein or any generalisation thereof and during the prosecution of the present application or of any application derived therefrom, new claims may be formulated to cover any such features and/or combination of such features. For example, the FIG. 6 RF ASIC 3 may further comprise a hardware accelerator. Additionally, the monitoring circuit may be provided on the RF ASIC 3 instead of on the baseband ASIC 5.

1. A radio frequency (RF) modem comprising:
a monitoring circuit;
an RF circuit having a demodulator, the RF circuit configured to receive RF signals;
a baseband processing unit configured to process baseband signals; and
a controller,
the controller being operable to enter the RF modem into a sleep mode in which the monitoring circuit is operational and the RF circuit and the baseband processing unit are not operational, the controller being responsive to an indication from the monitoring circuit to control the RF modem to enter a monitoring mode in which the RF circuit is operational and the baseband processing unit is not operational, the RF circuit in the monitoring mode being configured for data reception, and the controller being further operable to control the RF modem to exit the monitoring mode and to enter a baseband processing mode in which the baseband processing unit is operational to process data signals provided by the RF circuit.

2. The RF modem as claimed in claim 1, wherein the RF circuit further comprises a memory, and at least one register, the memory storing default values of the at least one register and the modem being operable in the monitoring mode to control writing of the default values to the at least one register.

3. The RF modem as claimed in claim 2, wherein the RF circuit further comprises a sequencer, the sequencer being operable in the monitoring mode to control powering up of the demodulator and the memory and to control the writing of the default values to the at least one register.

4. The RF modem as claimed in claim 1, wherein the RF circuit further comprises a processor operable in the monitoring mode to control configuration of the RF circuit.

5. The An RF modem as claimed in claim 4, wherein the RF circuit further comprises an analogue to digital converter and digital logic, and wherein the processor is operable to control the RF circuit in the monitoring mode to perform automatic gain control.

6. The RF modem as claimed in claim 4, wherein the RF circuit further comprises an analog analogue to digital converter and digital logic, and wherein the processor is operable to control the RF circuit in the monitoring mode to process a received information signal.

7. The RF modem as claimed in claim 6, wherein the baseband processing mode is an active mode in which the RF modem is operable to send and receive data.

8. The RF modem as claimed in claim 1, wherein the baseband processing mode is a second monitoring mode in which the baseband processing unit is powered and controlled to process a received information signal.

9. The RF modem as claimed in claim 8, operable in response to a determination that the received information signal meets predetermined criteria to exit the second monitoring mode and to enter an active mode in which the RF modem is operable to send and receive data.

10. The A method of operating a radio frequency (RF) modem the RF modem comprising:
a monitoring circuit;
an RF demodulator circuit configured to receive RF signals;
a baseband processing unit configured to process baseband signals; and
a controller,
the method comprising:
controlling the RF modem to enter a sleep mode in which the monitoring circuit is operational and the RF demodulator circuit and the baseband processing unit are not operational;
controlling the RF modem to respond to an indication from the monitoring circuit by entering a monitoring mode in which the RF demodulator circuit is operational for data reception and the baseband processing unit is not operational; and
controlling the RF modem to exit the monitoring mode and to enter a baseband processing mode in which the baseband processing unit is operational to process data signals provided by the RF demodulator circuit.

11. The method of claim 10, wherein the RF circuit further comprises a memory and at least one register, the memory storing default values of the at least one register and the method further comprising:
writing the default values to the at least one register while in the monitoring mode.

12. The method of claim 11, wherein the RF circuit further comprises a sequencer, the method further comprising:
in the monitoring mode the sequencer controlling powering up of the demodulator and the memory and controlling the writing of the default values to the at least one register.

13. The method of claim 10, wherein the RF circuit further comprises a processor, the method further comprising:
in the monitoring mode the processor controlling configuration of the RF circuit.

14. The method of claim 10, wherein the RF circuit further comprises an analog to digital converter and digital logic, the method further comprising:
in the monitoring mode the processor controlling the RF circuit to perform automatic gain control.

15. The method of claim 13, wherein the RF circuit further comprises an analog to digital converter and digital logic, the method further comprising:
in the monitoring mode the processor controlling the RF circuit to process a received information signal.

16. The method of claim 15, wherein the baseband processing mode is an active mode in which the RF modem is operable to send and receive data.

17. The method of claim 10, wherein the baseband processing mode is a second monitoring mode in which the baseband processing unit is powered and controlled to process a received information signal.

18. The method of claim 17, the method further comprising:
determining that the received information signal meets predetermined criteria; and
in response to the determining, exiting the second monitoring mode and entering an active mode in which the RF modem is operable to send and receive data.

19. The method of claim 10, in which the RF modem is disposed in a mobile communications device.

20. The RF modem of claim 1, in which the RF modem is disposed in a mobile communications device.
